(19) United States
(12) Patent Application Publication
(10) Pub. No.: US 2007/0108427 A1
(43) Pub. Date: May 17, 2007

(54) AUTOMATIC BAGGAGE LIFT LEVELING AND LIFT SYSTEM AND APPARATUS FOR SUPPORTING SAME FROM A MOVEABLE STRUCTURE SUCH AS A JET BRIDGE

(76) Inventor: Dave W. SMITH, Calgary, AB (CA)

Correspondence Address: SEAN W. GOODWIN, 222 PARKSIDE PLACE, 602-12 AVENUE S.W., CALGARY, AB, T2R 1J3, CA

(21) Appl. No.: 11/467,874

(22) Filed: Aug. 28, 2006

Related U.S. Application Data
(60) Provisional application No. 60/596,051, filed on Aug. 26, 2005.

(51) Int. Cl. B66D 1/00

(52) U.S. Cl. 254/266

(57) ABSTRACT

A baggage lift system connected between an elevated inclined jet bridge and the ground utilizes actuators which have the ability to change their effective length in order to level the load when lowered to the ground and align the load with the angle of the jet bridge when raised which facilitates safe and effective loading and unloading of baggage and other loads to and from the jet bridge.

### CROSS REFERENCE TO RELATED APPLICATIONS

This application is a regular US Patent application claiming priority of pending U.S. Provisional Patent application Ser. No. 60/596,051 filed Aug. 26, 2005, the entirety of which is incorporated herein by reference.

### FIELD OF THE INVENTION

Embodiments of the invention relate to lifts, lifts cantilevered from other support structures and levelling systems for loading to structures which vary in inclination. More particularly, embodiments of the invention relate to baggage lifts supported from a structure such as a jet bridge which provide a level position for loading carts or other devices at ground level and which align the load at an inclination corresponding to the structure when lifted.

### BACKGROUND OF THE INVENTION

Lifting aids or devices are known for raising loads from a ground surface to an elevated structure, such as lifting baggage carts and the like from the ground for loading to and from an aircraft.

Jet bridges are typically used for accessing elevated access doors of aircraft. Adjacent to the aircraft, the jet bridge has an exit door to a landing and stairs leading down to the tarmac which enables access outside the jet bridge and to the baggage hold of the aircraft. In the last few years, a problem has developed in the air travel industry with carry-on baggage. Increasingly, passengers are arriving at the door of regional aircraft, typically smaller commuter aircraft, with baggage that cannot be taken into the aircraft passenger area because it is too large or there is no room onboard.

Currently, this baggage is being handled by airline staff who must take the bags out the exit door of the jet bridge and down the stairs on the outside of the jet bridge to the baggage hold of the aircraft or the reverse for an inbound flight. This is time consuming, staff intensive, and has a high injury rate because of the weight of the baggage and the slope of the stairs.

An additional complication in the technology is that the design of jet bridges varies widely with no consistency in other equipment which is hung underneath. Several manufactures have proposed or built lifts that attach to the jet bridge by welding and bolting and which have a capacity of about 500 lbs and uncertainty as to the strength of the upper structure. These lifts typically consist of a small platform on which the bags are loaded and which travel to ground level for manual unloading to a cart which is then taken to the aircraft baggage hold. Applicant is not aware of any of these known lifts which is capable of supporting or raising and lowering a baggage cart which may weigh up to about 1000 lbs when loaded.

Further, jet bridge modifications are expensive and are generally discouraged. Welding in the vicinity of aircraft and the airport tarmac is similarly discouraged due to the prevalence of aircraft fuel and other combustibles.

A further challenge is encountered in providing a lift to the jet bridge as the jet bridge is typically inclined and the cross slope can change from 0 to up to a 1 in 7 slope. Conventional lift apparatus supported from the jet bridge and which are aligned to the slope of the jet bridge are in a different plane than the ground when lowered, hindering loading of a baggage cart and requiring manual loading of each individual piece of baggage. Similarly, lifts which are aligned to the ground are not aligned with the jet bridge and therefore one cannot transport a baggage cart to and from the jet bridge. Further use of a ground-aligned lift may present safety issues for personnel loading baggage from the elevated jet bridge to the lift.

There is a demonstrated need for a lift apparatus which adapts to an existing elevated structure, such as a jet bridge, without significant modification and is adaptable to variations in angular alignment between the elevated structure and the ground over which the structure is positioned.

### SUMMARY OF THE INVENTION

Embodiments of the invention provide automatic lift ground levelling and jet bridge angle adjustment. Substantially horizontal alignment of the lift structure at ground level permits a load supporting structure such as a loaded baggage cart to be rolled onto the lift. When raised to the elevated position, the inclined, aligned position of the lift permits safe loading for transport of the load to the ground below.

In a broad aspect of the invention a lifting apparatus for conveying a load between a lower surface and an elevated inclined surface comprises: a first actuator connected to a high point of the inclined surface and having an actuator axis extending towards the lower surface and a second actuator connected between a low point of the inclined surface and being spaced from and parallel to the axis of the first actuator; and a load supporting structure for supporting the load and having a first end supported by the first actuator and a second end supported by the second actuator, wherein the load supporting structure is movable axially along the first and second actuators between a first lowered position and a second elevated position; wherein when the load supporting structure is in the first lowered position, the second actuator has a first effective length shorter than that of the first actuator, the load supporting structure is substantially parallel to the lower surface; and when the load supporting structure is in the second elevated position, the second actuator has a second effective length of about that of the first actuator and load support structure is substantially parallel to the elevated inclined surface.

The effective length of the second actuator can be achieved in a variety of ways such as a telescoping portion which collapses to cause the second actuator to be shorter than the first or in the case where the load is engaged through fasteners connected between the actuators and the load can be achieved by permitting the second actuator to disengage the load and to travel past the co-operating fastener permitting engagement of the first actuator in advance of the second actuator.

In one embodiment, a mono beam multi-adjustable clamping system enables adaptation of the lift system for support from virtually any jet bridge of other elevated structure. The lift controls are interlocked with the jet bridge to sympathetically adjust the ground engaging portions should the jet bridge elevation be changed. Further, the lift controls are designed to disengage when the lift reaches extremes in position including ground-engagement and jet bridge alignment. Further the lift is interlocked to avoid actuation when the jet bridge safety gate is open. The gate is also mechanically locked to prevent it from opening if the lift is not at the jet bridge elevation.

Accordingly in the present proposal, a multi-adjustable clamping system was developed to allow the lift to be attached almost anywhere under the jet bridge and adjusted in both horizontal directions and vertically (3 axis adjusting system). This is done by using a single large (approx. 7″×7″) hollow structural steel member which can be moved horizontally in two directions on the main jet bridge beams. This single member has on the outer end of it a similarly large cross member extending to the vertical tracks for the lift. This arrangement allows for almost complete adjustability of the structure in the field and transfer of a lift to other locations.

In one embodiment of the invention, the load supporting structure is a platform wherein a baggage cart is movable and can be rolled onto the platform when it is at ground level which eliminates the need for double handling of the bags. In another embodiment using fasteners to engage the laod supporting structure, the baggage cart, wheel chair or the like is the load supporting structure.

### BRIEF DESCRIPTION OF THE DRAWINGS

FIG. 1 is a side view of a highly inclined jet bridge with an embodiment of the lift platform at the ground and level thereto and having received a baggage cart thereon, the first and second elevating members being behind the frame members;

FIG. 2 is a side view of the lift according to FIG. 1 wherein the lift is partially elevated and the platform conforms with the angle of the jet bridge, the first and second elevating members being behind the frame members;

FIG. 3 is a side view of the lift according to FIG. 1 wherein the lift is elevated to the jet bridge platform and the platform conforms with the angle of the jet bridge, the first and second elevating members being behind the frame members;

FIG. 4 is an end view of the lift according to FIG. 1 wherein the lift platform is level with the ground and illustrating the mono-beam;

FIG. 5 is a partial perspective view of the mono-beam having a mounting portion and one vertical flange with a lift rail secured therealong;

FIG. 6 is a view of the lift with the platform on the ground in the level loading position;

FIG. 7 is a upward view of the low side rail and closed jet bridge safety gate;

FIG. 8 is a view of the lift with the platform on the ground in the level loading position;

FIG. 9 is a view of the lift with the raised to the jet bridge platform and wherein the platform is parallel with the jet bridge angle;

FIG. 10 is a close-up view of the telescoping members lift with the platform on the ground in the level loading position;

FIG. 11 is an underside view from under the jet bridge towards the lift illustrating the mono-beam clamped to the I-beam underside of the jet bridge and with a view of the lift with the platform on the ground in the level loading position;

FIG. 12 is a view of the mounting portion of the mono-beam with the high side vertical mounting flanges supporting the lift rails for the lift frame;

FIG. 13 is an underside view from the baggage side of the jet bridge looking under the jet bridge illustrating the mono-beam clamped to the I-beam underside of the jet bridge;

FIG. 14 is a view of the lift drive, motor, cable drums, cables, four-bar mount and attachment to the vertical flange with the drive in the top-lift position as the platform is elevated off of the ground and tension are in the lift cables;

FIG. 15 upward view of the jet bridge showing the safety gate and upper structure of the lift rails and drive;

FIG. 16 is a view of one proximity sensor, model Siemens 3RG4014-0KB00 for the drive interlock;

FIG. 17 is another view of the lift drive, motor, cable drums, cables, four-bar mount and attachment to the vertical flange, with the drive in the mid-position as the platform is in contact with the ground in the normal loading position;

FIG. 18 is an underside view of the platform in the elevated position and illustrating the ground engaging castors;

FIG. 19 is a view of the gat, gate rails and jet bridge platform;

FIG. 20 is a perspective view of the lift frame with the platform on the ground and a baggage cart poised for loading onto the platform ramp;

FIG. 21 is a plan view of a portion of a rail engaged with an elevating member for axial movement of the lift therealong, a pulley at a top of the elevating member having been removed for clarity;

FIG. 22 is a side view of a highly inclined jet bridge with an embodiment of the lift at the ground and level thereto having a baggage cart as the load supporting structure and cooperating fasteners for engaging the lift with the baggage cart; and

FIG. 23 is a side view of the lift according to FIG. 22 wherein the lift is partially elevated and the baggage cart conforms with the angle of the jet bridge; and

FIG. 24 is a detailed view of the co-operating fasteners comprising hooks on the elevating members and loops on the baggage cart in the lowered position and in an embodiment of a lift according to FIG. 22, the rails being removed for clarity.

### DETAILED DESCRIPTION OF THE PREFERRED EMBODIMENT

Embodiments of the invention are discussed herein in the context of a lift connectable to a jet bridge for use with loading and unloading carry-on baggage from the jet bridge to the ground below to permitting stowing said carry-on baggage in the hold of an aircraft. Description in this context is in no way intended to limit the scope of the invention to lifts for use with jet bridges and aircraft only or to the loading of carry-on baggage. Embodiments of the invention are applicable to lifts connectable between any elevated variable angle surface and a lower surface which may be angled or which is generally a substantially horizontal surface for any type of load.

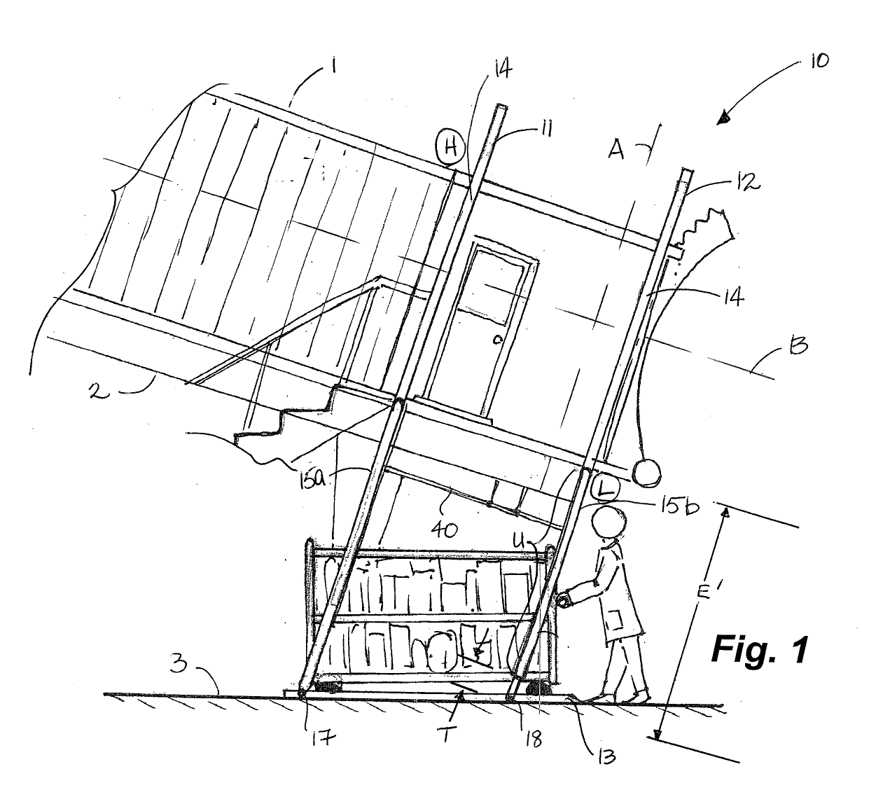

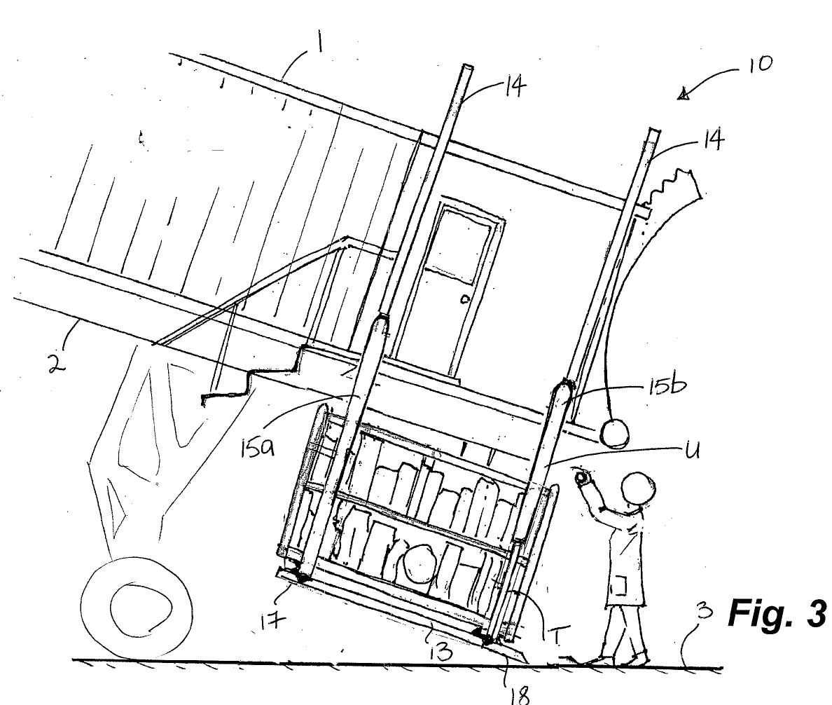

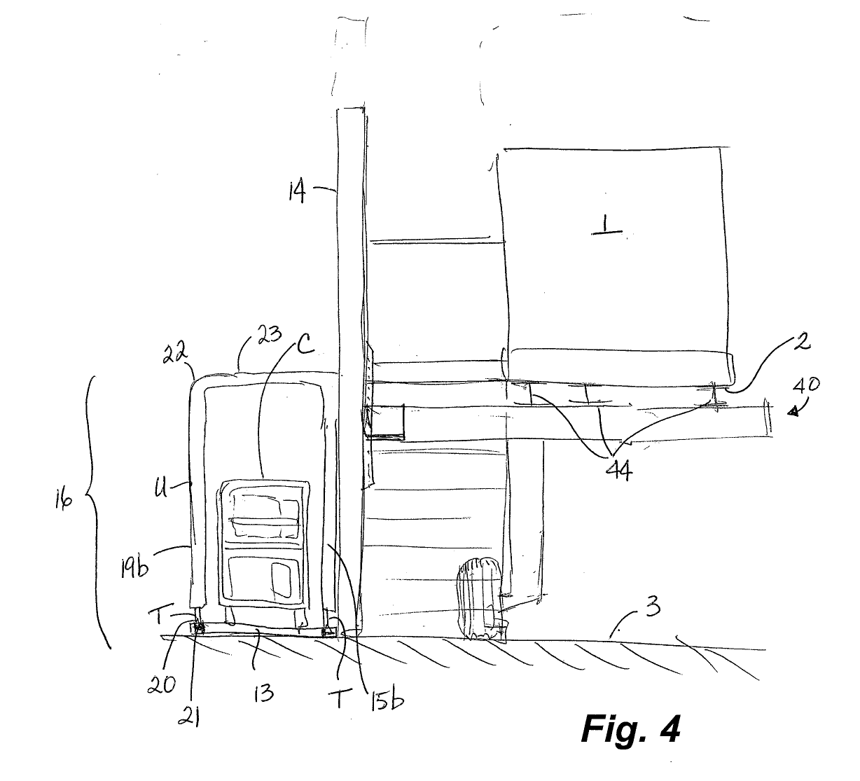

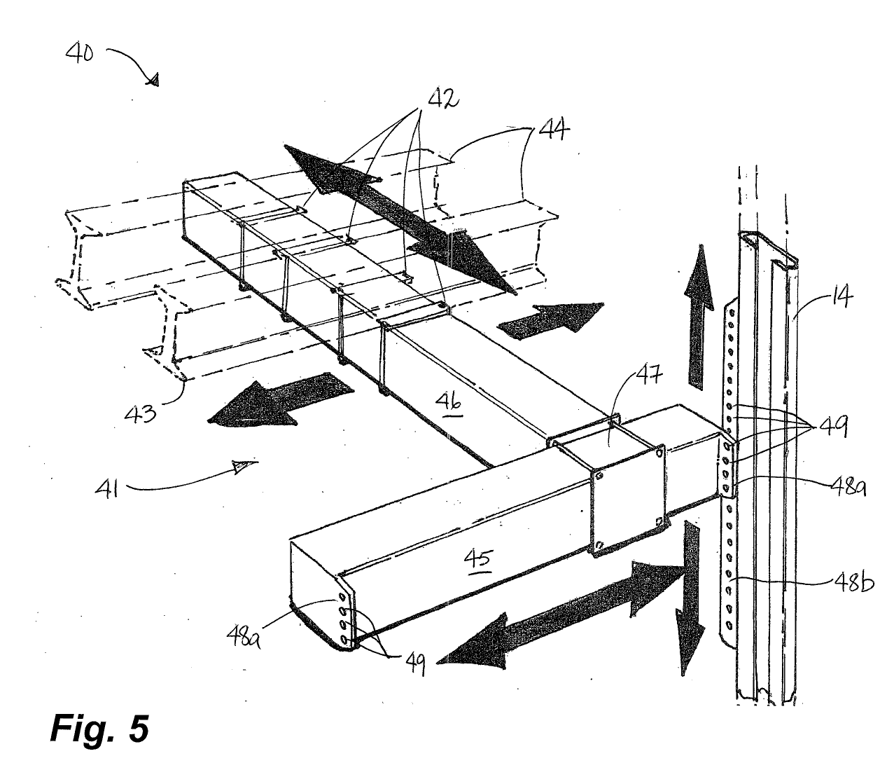

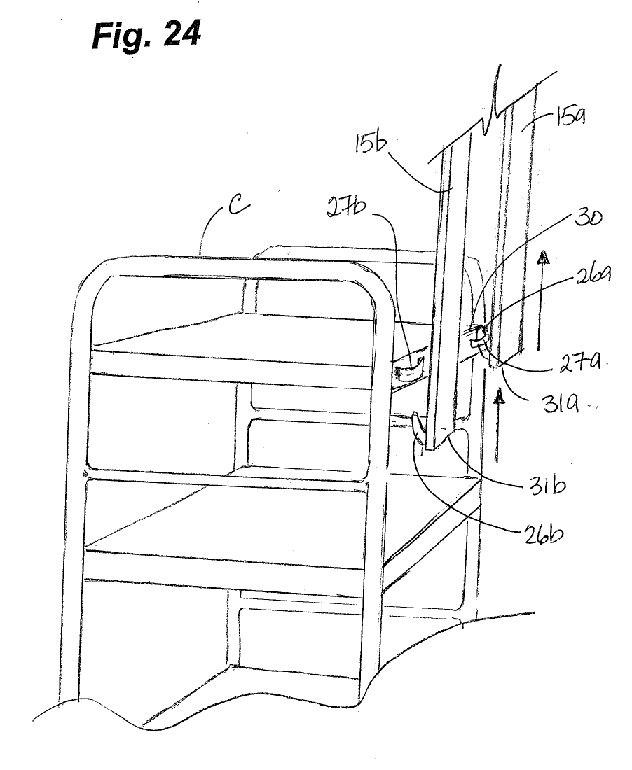

Having reference to FIGS. 1-4 and 22-24, a jet bridge 1 is shown in an extreme angle of repose, pivotable about a hinge point off-drawing to the left, for variable angle connection between an elevated gate at an airport and the door of an aircraft, typically lower than the gate elevation. In one embodiment, a lift structure 10 is supported from an underside 2 of the variable angle jet bridge 1. The lift structure 10 comprises first and second spaced apart, substantially parallel actuators 11,12 connected between the jet bridge 1 and a load supporting structure 13. The first and second actuators 11,12 extend toward a lower surface, typically horizontal surface 3, such as the ground and have an actuator axis A substantially perpendicular to a jet bridge axis B. Each of the first and second actuators 11,12 comprises a bracketing upstanding pylon, fixed portion or rail 14 oriented substantially perpendicular to the angle of the jet bridge 1 and an elevating member 15 axially moveable thereon. As shown also in FIGS. 4 and 5, the rails 14,14 are supported on a mono beam clamping system 40 connected to the underside 2 of the jet bridge 1 without modification of the jet bridge 1, to bear the reactive lifting loads and to permit positioning of the rails 14,14 in three dimensions. The multi-adjustable clamping structure 40 is discussed later in greater detail.

The lift structure 10 is capable of accepting and supporting a load C, such as a baggage cart or a wheelchair or the like. First and second elevating members 15a,15b engage the load supporting structure 13 which extends between the first and second elevating members 15a,15b for forming a substantially rigid structure 16. The first and second elevating members 15a,15b are actuated for axial movement of the substantially rigid structure 16 along the rails 14,14 between a ground engaging, lowered position wherein the load supporting structure 13 is aligned substantially parallel with the ground 3 and a raised position at the jet bridge 1 wherein the load supporting structure 13 is aligned substantially parallel to the angle of the inclined surface of the jet bridge 1. This capability would be trivial were it not for the fact that the jet bridge cross slope may vary from zero to up to a 1 in 7 slope, meaning that were it not for this ability, the load supporting structure 13 would be at a 1 and 7 slope at ground level which would make it impossible to push a 1000 lbs. loaded baggage cart onto it.

In one embodiment, the lift structure 10 comprises the first actuator 11 oriented at a high point H of the inclined jet bridge 1, typically the side adjacent the hinge point (not shown) and the second actuator 12 at a low point L of the inclined jet bridge 1, typically the side adjacent the aircraft. The first and second actuators 11,12 have independent characteristics permitting variable inclination of the load supporting structure 13. The load supporting structure 13 is pivotally connected at a first end 17 to the first actuator 11 and at a second opposing end 18 to the second actuator 12. The load C is supported by the load supporting structure 13 and, when lifted, is positioned at substantially the angle of the jet bridge 1 as a result of the substantially perpendicular positioning of the fixed rails 14,14 relative to the jet bridge 1, the second actuator 12 having achieved a second effective length of about that of the first actuator 11. When the load C is lowered and the second, second low end 18 of the load supporting structure 13 touches the ground 3 and the second actuator 12 assumes a first effective length shorter than that of the first actuator 11 which permits the first actuator 11 to continue to lower and position the first high end 17 of the load supporting structure 13 on the ground 3, the load supporting structure 13 now being aligned substantially parallel to the ground 3.

In one embodiment as shown in FIGS. 4, 6 and 20, the load supporting structure 13 is a platform which is pivotally connected at the first and second opposing ends 17,18 to each of the first and second actuators 11,12, forming the substantially rigid structure 16. For better supporting the platform 13, the lift structure 10 further comprises first and second upstanding frame members 19a,19b connected at lower ends 20a,20b to the first and second opposing ends 17,18 of an opposite side 21 of the platform 13 and at upper ends 22,22 through crossbars 23 to the first and second elevating members 15a,15b for forming the rectangular rigid structure 16. The second elevating member 15b and the second frame member 19b each comprise an upper portion U and a lower telescoping portion T to which the platform 13 is attached. The first elevating member 15a and the first frame member 19a are of a fixed length. The platform 13 is capable of pivoting about the connection to the first elevating member 15a and the first frame member 19a as the telescoping portions T collapse and extend.

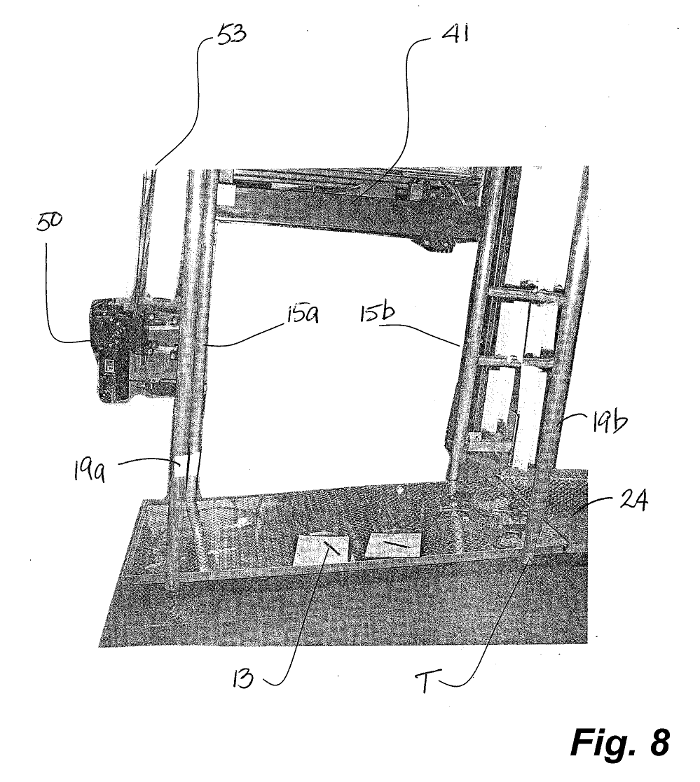

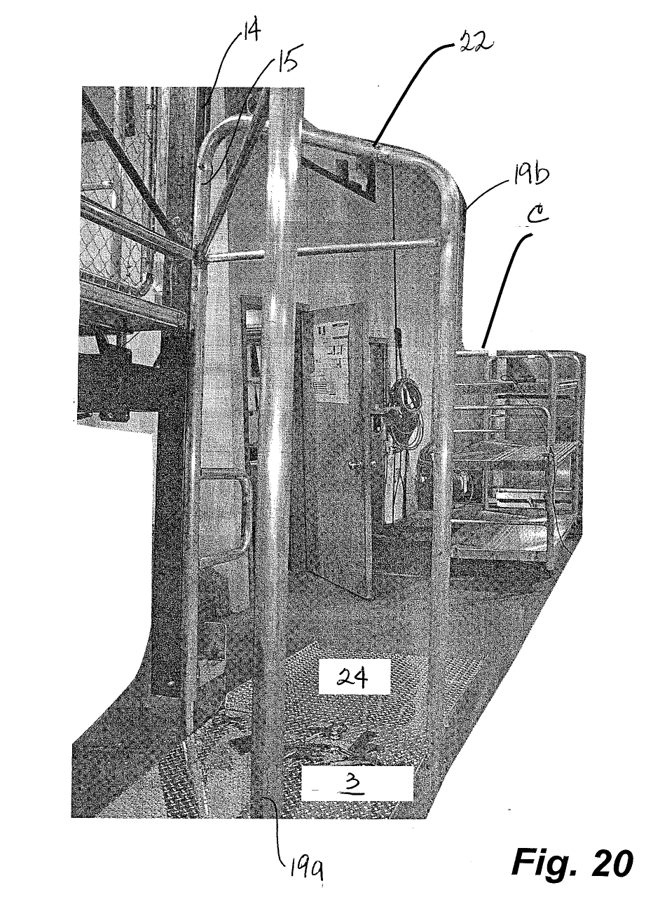

As shown in FIGS. 1 and 8 in the lowered position, the telescoping portions T of the second elevating member 15b and the second frame member 19b collapse when the second end 18 of the platform 13 engages the ground 3 to a first effective length E′, which is shorter than the first elevating member 15a and the first frame member 19a, sufficient to permit the first end 17 of the platform 13 (high side) to continue to lower and conform to the elevation of the ground 3 and thereby the platform 13 assumes a substantially level orientation at the ground 3. Thus, a load C, such as a baggage cart, can be rolled onto the platform 13 with ease. Typically, the baggage cart C is then secured to the platform by a raised lip or guard rail at the first end 17 of the platform 13 (high side) and by a pivoting platform access ramp 24 (best seen in FIG. 20) at the second end 18 which can be raised to block the second end 18 once the baggage cart C is in place on the platform 13.

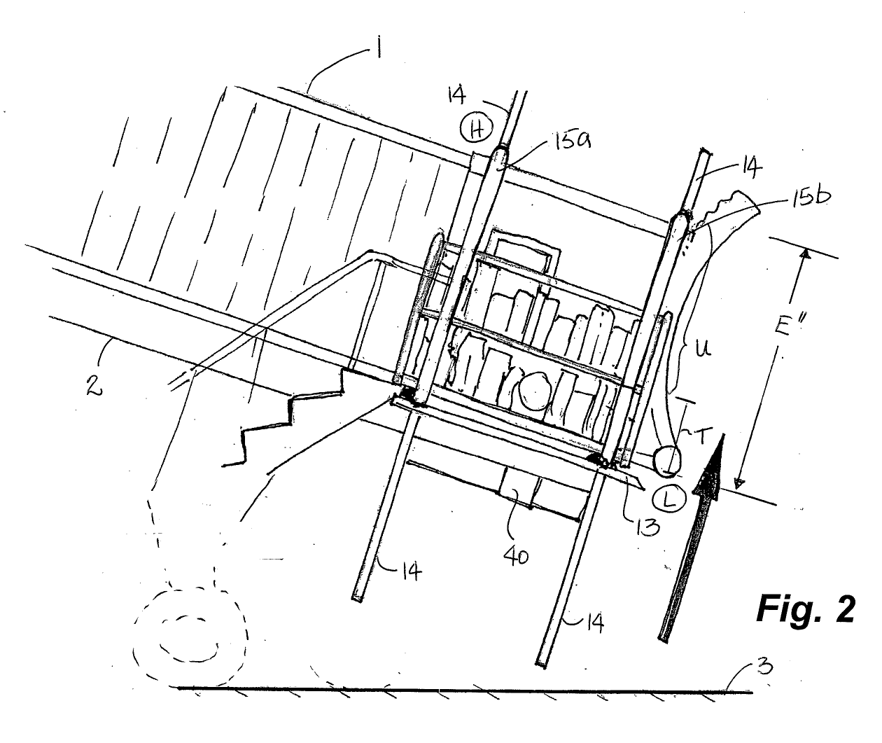

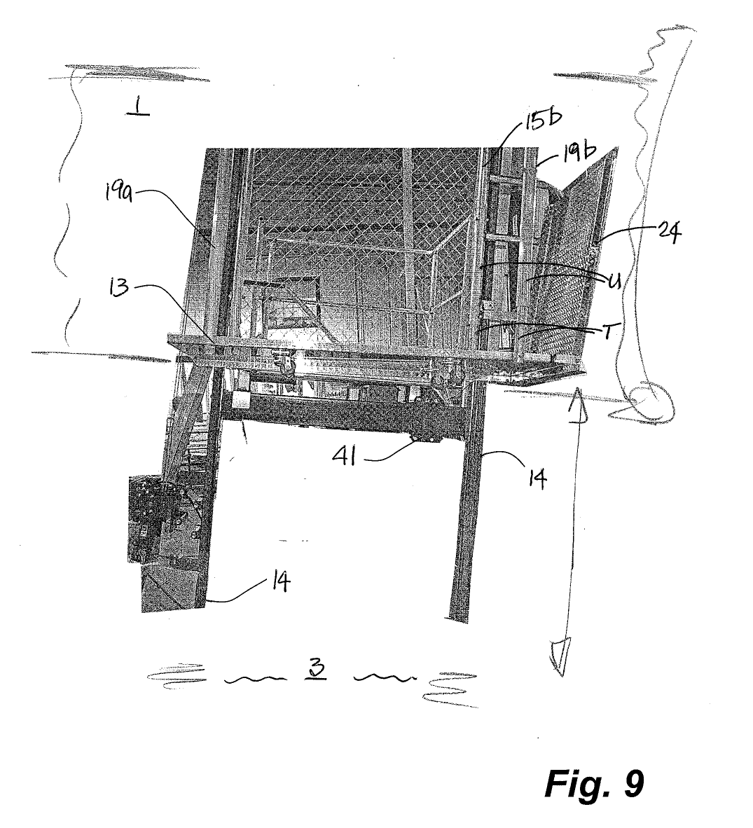

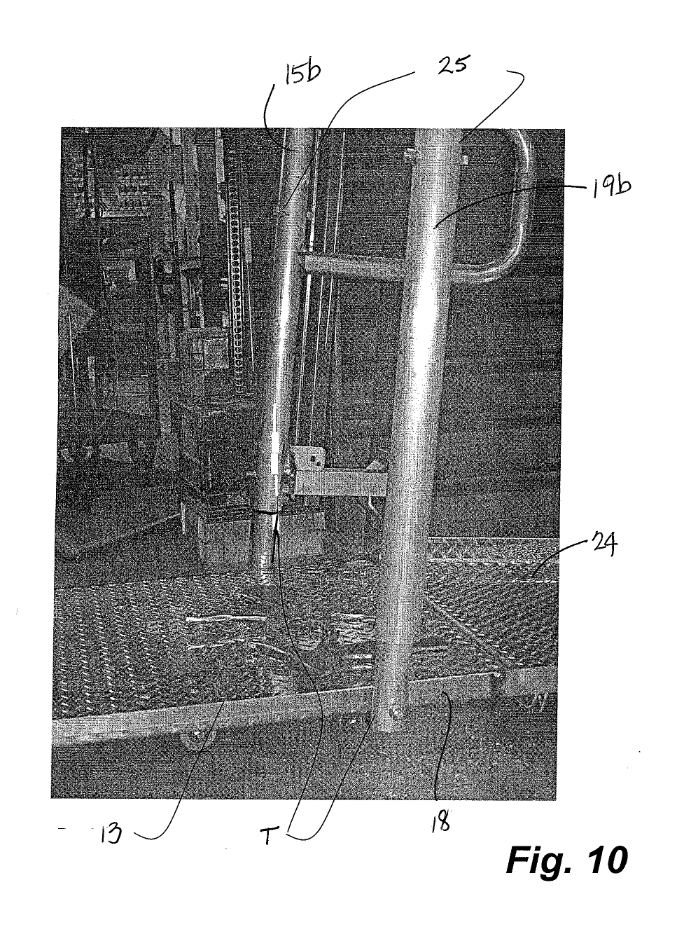

Turning to FIGS. 2 and 9, once the lift structure 10 is actuated and the substantially rigid structure 16 begins to rise to the second raised position, the first actuator 11 immediately lifts the first end 17 of the platform 13 from the ground 3. The telescoping portions T of the second elevating member 15b and the second frame member 19b telescopically extend until such time as the second actuator 12 and frame member 19b assume a second effective length E″ of about that of the first actuator 11 which positions the platform 13 at an angle substantially aligned with the angle of the jet bridge 1. A stop 25, such as a through-bolt, is positioned in each of the second elevating member 15b and the second frame member 19b to arrest further extension of the telescoping portions T when the substantially rigid rectangular structure 16 is raised above the ground 3 and is aligned substantially parallel to the jet bridge 1. FIG. 10 illustrates the telescoping members T and the through-bolts 25 in closer detail.

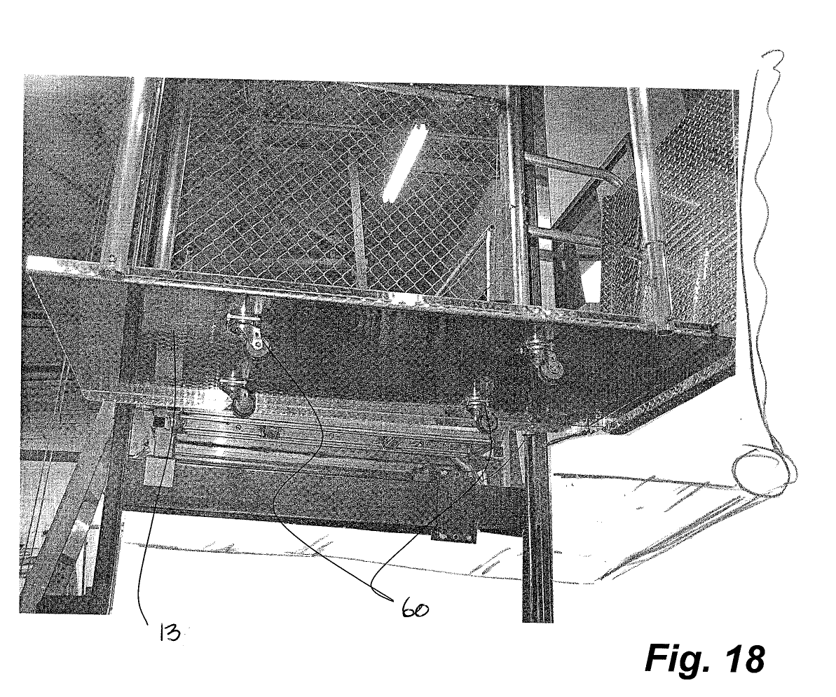

With reference to FIG. 18, castors 60 on an underside 61 of platform 13 ensure that movement of the jet bridge 1 is accommodated without dragging of the platform 13.

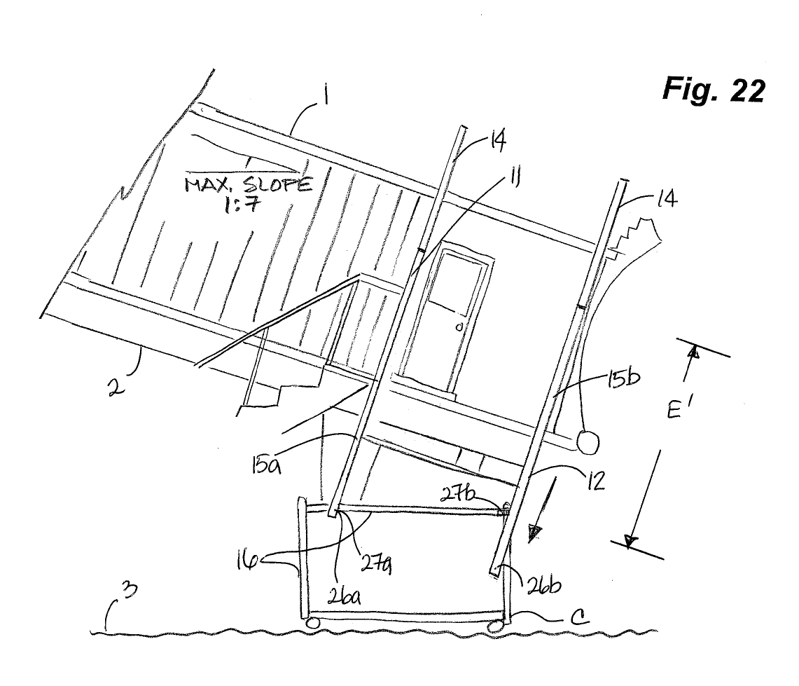

In an embodiment of the invention as shown in FIGS. 22-24, the load supporting structure 13 is the baggage cart C, wheelchair or the like. The structure of the cart C forms the rigid structure 16 extending between the first and second actuators 11,12. Cooperating first and second fasteners 26a, 26b,27a,27b act to pivotally engage the load supporting structure 13 to the first and second actuators 11,12. In one embodiment second fasteners 27a,27b, such as loops, are attached to the load supporting structure 13, typically adjacent an upper edge 30 of the load supporting structure 13. First fasteners 26a, 26b, typically protrusions such as hooks, latches or outwardly and upwardly facing pins or the like, are affixed adjacent a lower end 31a, 31b of each of the first and second actuator's elevating members 15a, 15b for pivotally engaging the loops 27a,27b on the load supporting structure 13.

The first and second elevating members 15a, 15b are oriented substantially perpendicular to the angle of the inclined jet bridge 1 through substantially parallel connection to the rails 14,14 thus positioning the elevating member 15a of the first actuator 11 higher than that of the elevating member 15b of the second actuator 12.

As seen in FIG. 22 with the rigid structure 16 aligned substantially parallel to the ground 3, the first fastener 26b on the second elevating member 15b is lower than the loop 27b on the second end 18 of the load supporting structure 13 and thus disengages the load supporting structure 13 and shortens the effective length of the second actuator 12 to the first effective length E′ which permits the first actuator 11 to continue to lower and position the first end 17 on the ground 3.

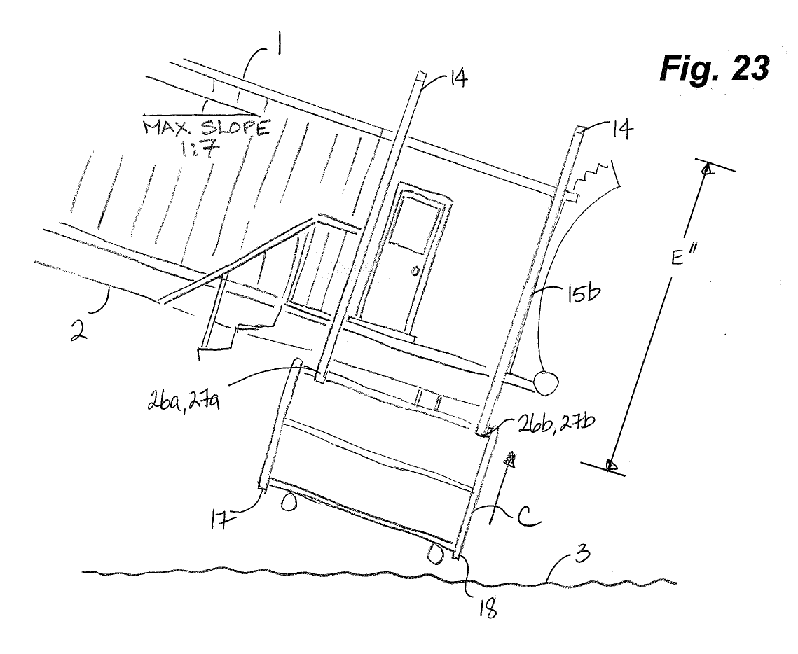

With reference to FIG. 23, as the elevating members 15a, 15b are actuated to raise the load supporting structure 13, the first fastener 26a on the first elevating member 15a, being higher than the first fastener 26b on the second elevating member 15b engages the loop 27a at the first end 17 of the load supporting structure 13 and lifts the first end 17 of the load supporting structure 13 at an angle relative to the second end 18 of the load supporting structure 13, the load supporting structure 13 pivoting thereabout. As the first fastener 26b on the second elevating member 15b reaches the first fastener 26b on the second end 18 of the load supporting structure 13, the second elevating member 15b, extended to the second effective length E″, engages the loop 27b at the second end 18 of the load supporting structure 13 for lifting the second end 18, the load supporting structure 13 being lifted at the angle of the elevated inclined jet bridge 1.

Such a latch-in configuration could accept latch-in carts or wheelchair transporter lifts for taking wheelchairs over to aircraft and lifting them to the hold or to a bag loading belt.

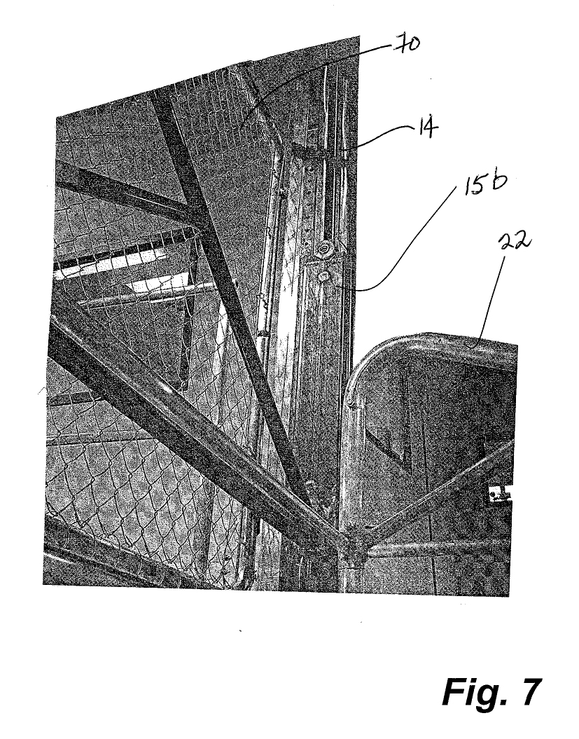

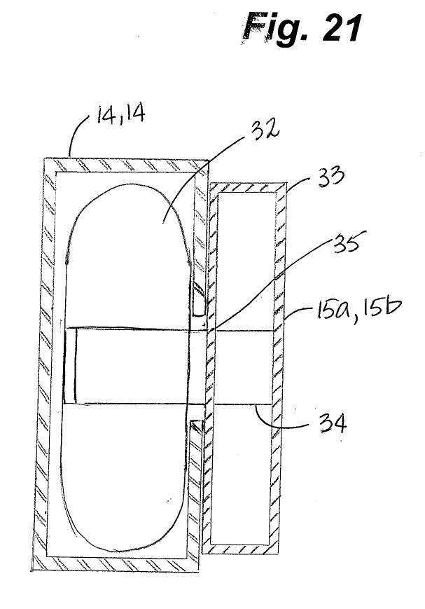

Best seen in FIG. 7 and FIG. 21, in one embodiment the elevating members 15a, 15b are connected to the rails 14,14, which are C-shaped, for axial movement therealong. Wheels 32 are connected adjacent a top end 33 of each of the first and second elevating members 15a,15b by pins 34 which permit the wheel 32 to ride within a channel 35 in the C-shaped rail 14 as the elevating members 15a,15b are actuated to raise and lower.

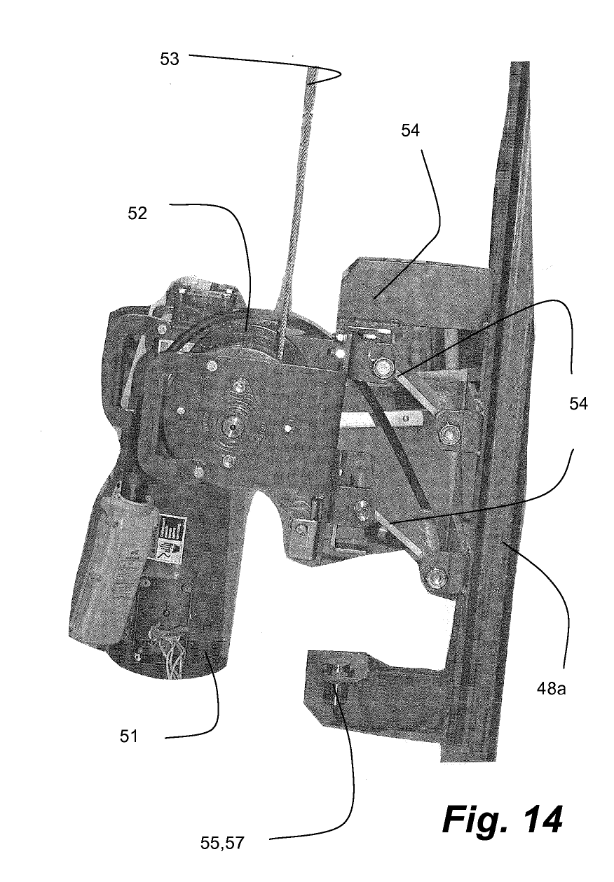

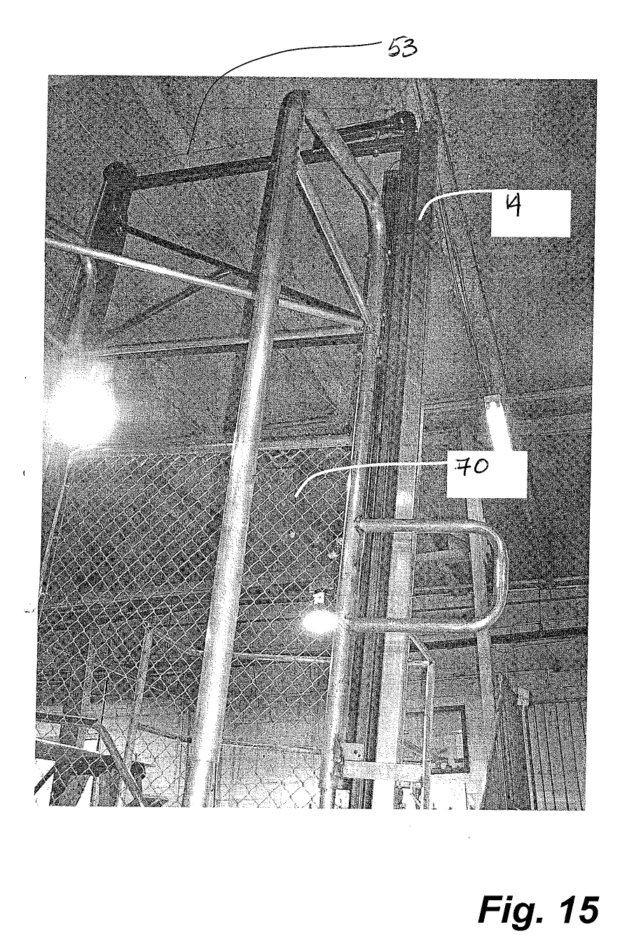

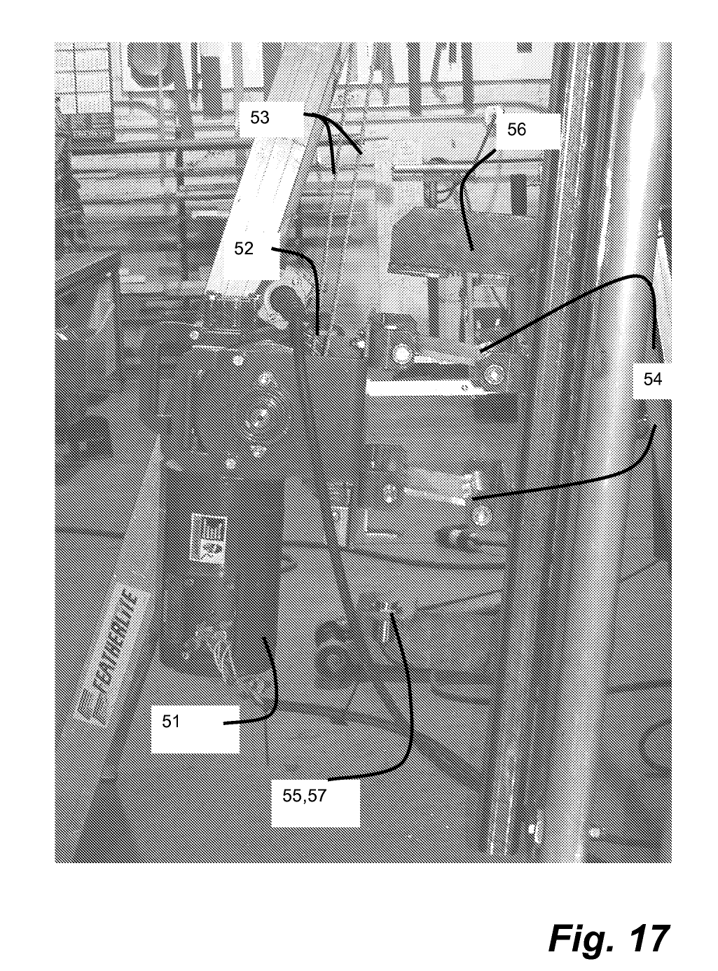

Actuation of the lift structure 10 may be through a variety of actuators having the appropriate interlocks. Jet bridges 1 typically utilize both electrical and hydraulic actuators. As shown in FIGS. 14 and 15 and in one embodiment, a combination electrical and cable lift drive 50 is implemented. An electrical winch motor 51 drives a pair of drums 52 and cables 53 for lifting the substantially rigid rectangular structure 16 up the rails 14,14 The electrical lift controls include interlocks to power down when the substantially rigid rectangular structure 16 engages the ground 3. More particularly, as the substantially rigid rectangular structure 16 contacts the ground 3, the borne weight on the drive 50 diminishes and the drive 50 can relax on its mount 54. The drive 50 is mounted on a four-bar linkage 54 permitting a range of motion. As shown in FIG. 17, when the substantially rigid rectangular structure 16 is lowered to the ground 3, the cables 53 slacken and simply without the reactive load, the drive 50 lowers, breaking a first proximity sensor 55 contact and signalling to stop the drive 50 and discontinue lowering of the substantially rigid rectangular structure 16.

As shown in FIG. 14 under full lifting load such as at the second elevated position at the jet bridge 1, the drive 50 is pulled upward slightly by the cables 53 to bear against an upper stop and actuates a second proximity sensor 56 to stop the drive 50.

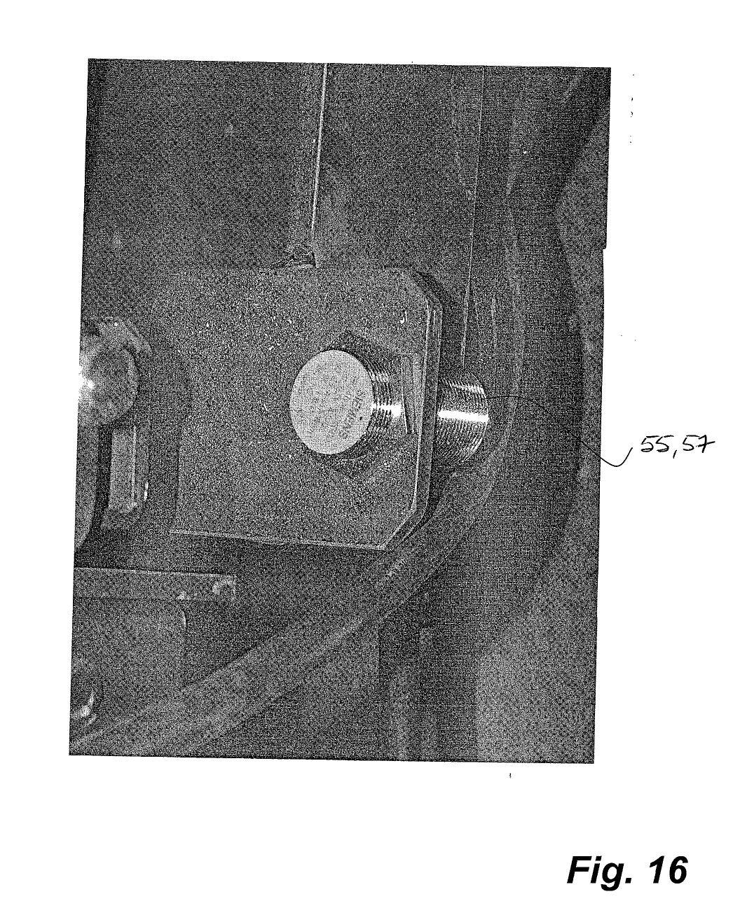

In other instances, the jet bridge 1 may be adjusted to fit a higher or a lower aircraft. In the case of a higher aircraft, the jet bridge 1 will be elevated, lifting the substantially rigid structure 16 from the ground 3 in the same action. The first proximity sensor 55 (FIGS. 14, 16 and 17), can be activated again and should the programming permit, the substantially rigid structure 16 is automatically lowered with respect to the ground 3.

In the opposite instance, if the jet bridge 1 is lowered to accommodate a lower aircraft, a third proximity sensor 57 or alternate program for the first sensor 55 (FIG. 17) causes the substantially rigid structure 16 to rise automatically to avoid driving the substantially rigid structure 16 into the tarmac 3. As the jet bridge 1 lowers, the cable drive 50 slackens further and the four-bar linkage 54 allows the motor 51 to drop further until the third proximity sensor 57 or first sensor 55 signals to raise the substantially rigid structure 16.

Optionally, each of the actuators 11,12 may be independently driven and further, the effective length E′, E″ of the second actuator 12 relative to the first actuator 11 may be achieved by varying the distance the second actuator 12 is driven along the rail 14 relative to that of the first actuator 11 regardless whether the actuators 11,12 engage the load C through a platform 13 or through other means such as the co-operating fasteners 26,27.

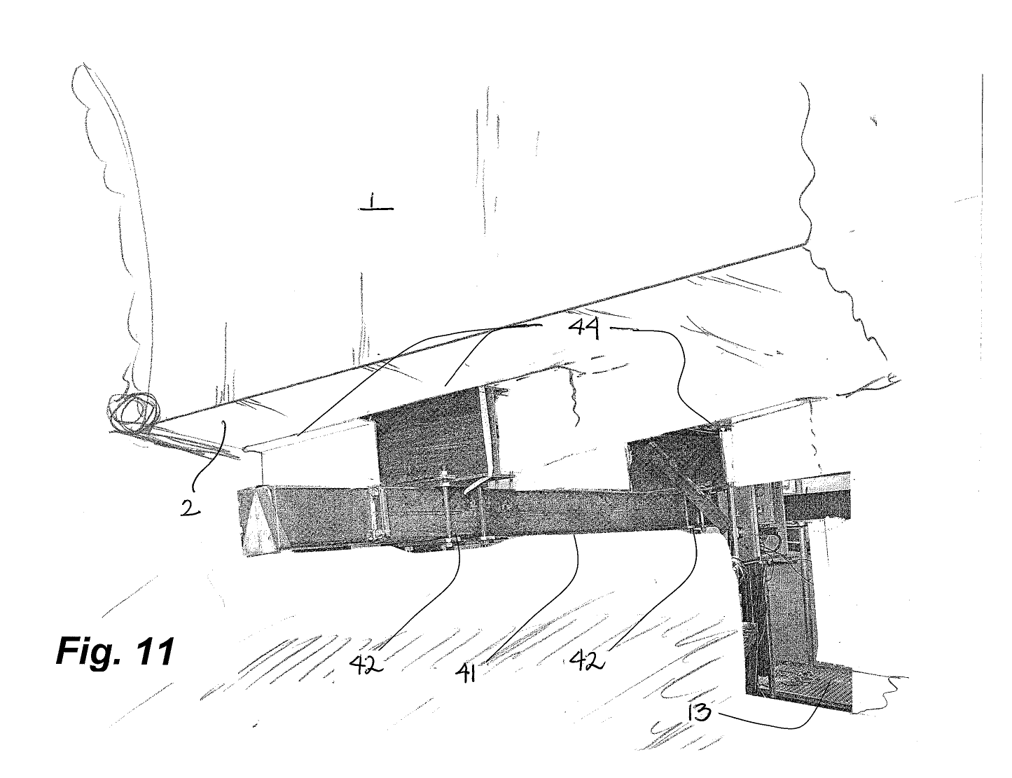

As previously stated and with reference to FIGS. 5, 9, 11 and 13, the lift structure 10 is connected by the actuators 11,12 to the underside 2 of the jet bridge 1 using a large, hollow, structural steel mono-beam 41 which is clamped to the underside 2 of the jet bridge 1. Clamps 42 engage exposed lower flanges 43 of “I”-beams 44 on the underside2 of the jet bridge1 and extend around the mono-beam 41. The clamps 42 permit the mono beam 41 to be adjusted to extend laterally more or less from the side of the jet bridge 1, transverse to the “I” beams 44. Further, the clamps 42 can move along the “I”-beams 44 to adjust the position of the lift structure 10 along the jet bridge 1. The elevation of the actuators 11,12 is adjustably positionable to the mono beam 41. Thus, the lift structure 10 is adjustable in three dimensions relative to the jet bridge 1.

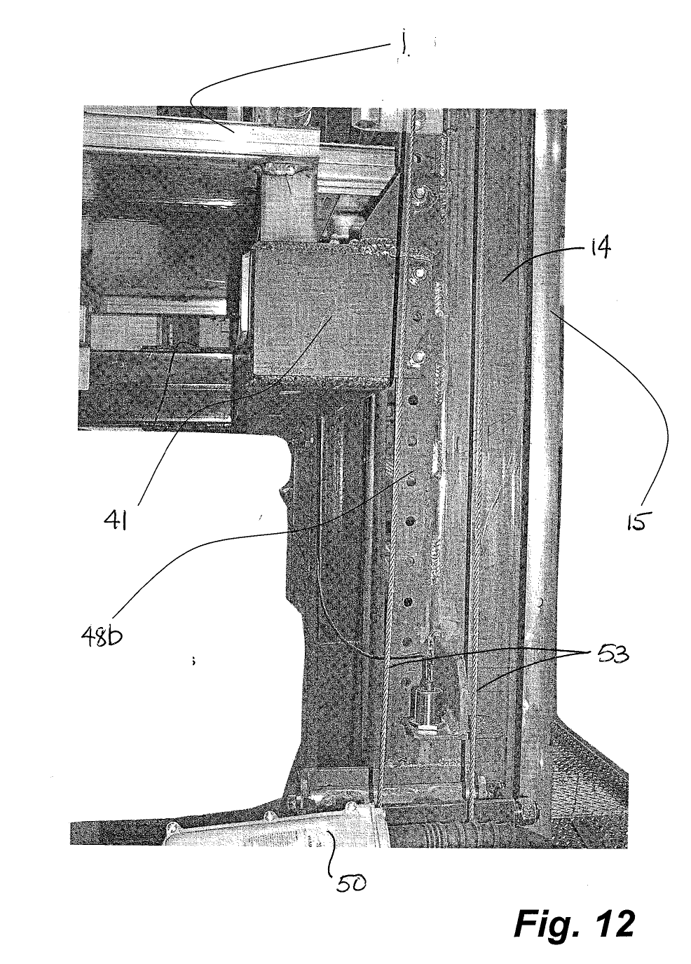

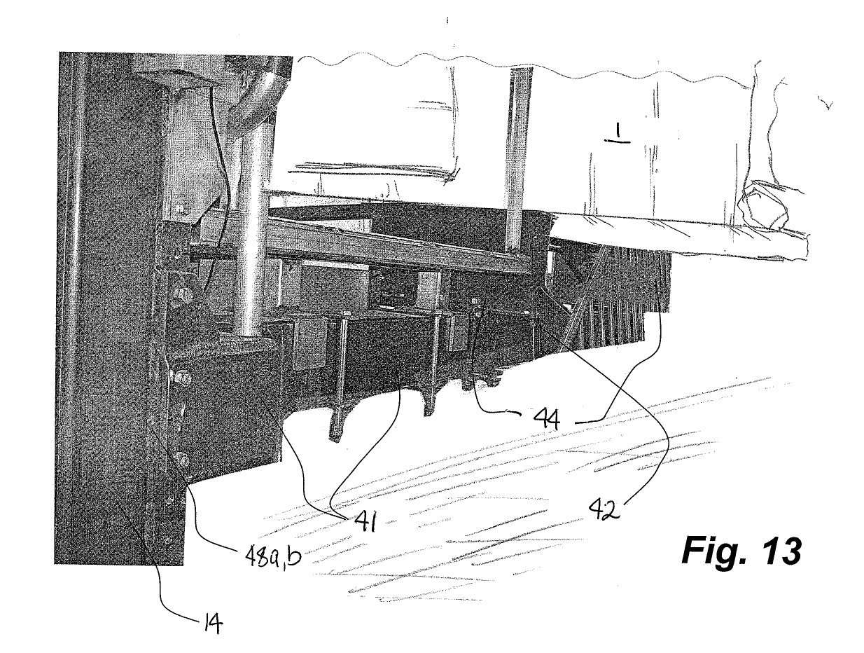

In one embodiment best seen in FIG. 5, the mono-beam 41 is “T”-shaped construction in plan view having a first beam 45 and second beam 46. The first beam 45 is connected at an intermediate point 47 to the second beam 46 to from a unitary mono bean 41 and is adjustable horizontally therealong. The second beam 46 is clamped to the jet bridge 1 as described above. The first beam 45 extends along the jet bridge 1 and parallel thereto. The rails 14,14 of the first and second actuators 15a, 15b are secured to the first beam 45. As shown in FIG. 12 (high side) and FIG. 13 (low side), flanges 48a are spaced apart and extend up and down from extreme ends of the first beam 45 for connection to corresponding flanges 48b on the rails 14,14. The flanges 48a, 48b contain a plurality of mounting holes 49 to permit initial height adjustment of the rails 14,14 and the lift structure 10 to fit each particular jet bridge 1.

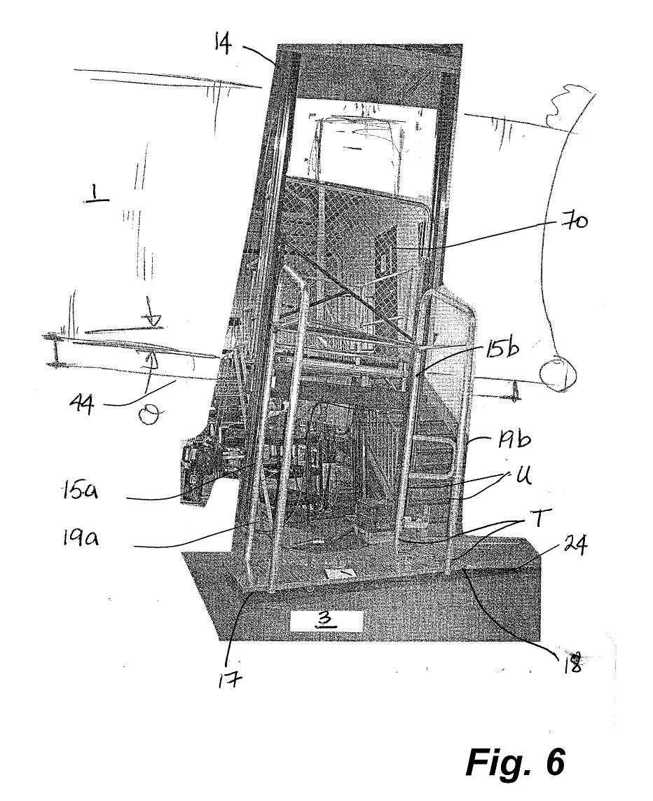

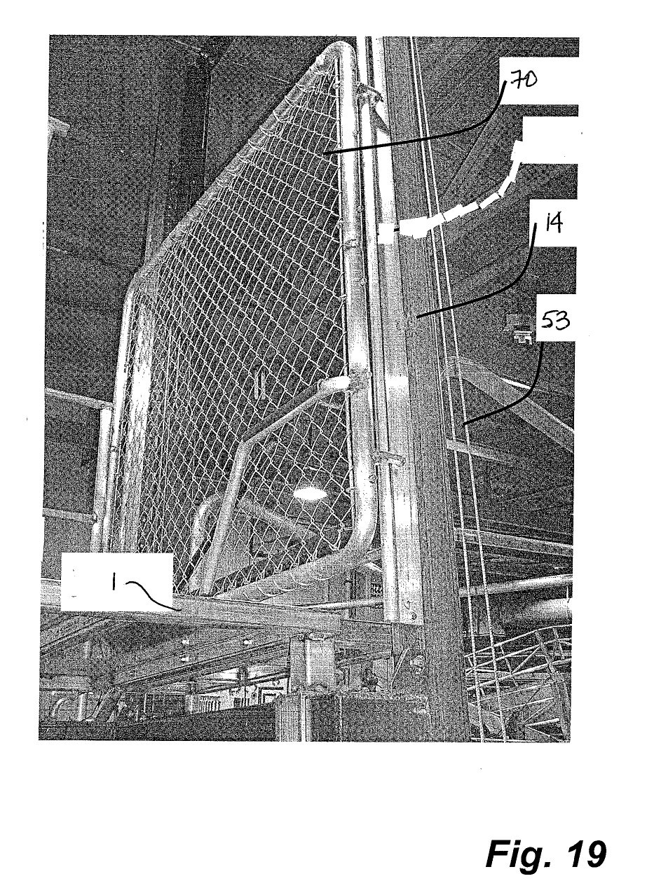

As shown in FIGS. 6, and 19 and in one embodiment, a safety gate 70 is installed between the rails 14,14 of the actuators 11,12. The gate 70 is movable on spaced pairs of wheels or slides guided on a tubular rail. The gate 70 is counterweighted to ease hand-lifting. A proximity sensor signals when the gate 70 is closed to enable operation of the lift structure 10. A mechanical interlock locks the gate 70 closed when the lift structure 10 is not at the jet bridge elevation. For example, a cam on the platform 13 will disengage the mechanical lock when the lift structure 10 is positioned at the jet bridge 1.

Preferably, actuation of the lift structure 10 is controlled by a fixed or handheld switch located close to the high side of the jet bridge so an operator can visualize people and hazards during operation of the lift structure.

The embodiments of the invention in which an exclusive property or privilege is claimed are defined as follows:

1. A lifting apparatus for conveying a load between a lower surface and an elevated inclined surface comprising:
a first actuator connected to a high point of the inclined surface and having an actuator axis extending towards the lower surface and a second actuator connected between a low point of the inclined surface and being spaced from and parallel to the axis of the first actuator; and
a load supporting structure for supporting the load and having a first end supported by the first actuator and a second end supported by the second actuator, wherein the load supporting structure is movable axially along the first and second actuators between a first lowered position and a second elevated position; wherein
when the load supporting structure is in the first lowered position, the second actuator has a first effective length shorter than that of the first actuator, the load supporting structure is substantially parallel to the lower surface; and
when the load supporting structure is in the second elevated position, the second actuator has a second effective length of about that of the first actuator and load support structure is substantially parallel to the elevated inclined surface.

2. The lifting apparatus of claim 1 wherein the load supporting structure is a platform pivotally connected at the first end to the first actuator member and at a second end to second actuator, the load adapted to be supported on the platform for axial movement between the first and second positions.

3. The lifting apparatus of claim 1 wherein the second actuator further comprises:
a fixed portion secured to the elevated inclined surface; and
an elevating member movable axially therealong, the elevating member having a lower end engagable with the load supporting structure.

4. The lifting apparatus of claim 3 wherein the elevating member further comprises:
an upper portion; and
a lower portion movable telescopically relative to the upper portion, the lower portion being connected to the load supporting structure, wherein
when the load supporting structure is in the first lowered position, the lower portion is telescopically collapsed so that the second actuator has the frist effective length shorter than that of the first actuator and the load supporting structure is substantially parallel to the lower surface; and
when the load supporting structure is in the second elevated position, the lower portion is telescopically extended so that the second actuator has the second effective length of about that of the first actuator and load support structure is substantially parallel to the elevated inclined surface.

5. The lifting apparatus of claim 1 wherein each of the first and second actuators further comprise:
a fixed portion secured to the elevated inclined surface; and
an elevating member movable axially therealong, the elevating member having a lower end engagable with the load supporting structure.

6. The lifting apparatus of claim 5 wherein:
each of the elevating members further comprise a first fastener for releasably engaging the load supporting structure, and
the load supporting structure further comprises a substantially rigid structure having second fasteners, the second fasteners being spaced apart to cooperate with the first fasteners of the elevating members, wherein
when the rigid structure is in the first lowered position, the substantially rigid rectangular structure is substantially horizontal and a first fastener of the first actuator is engaged with a second fastener of the substantially rigid rectangular structure and a first fastener of the second actuator is disengaged from a second fastener so that the second actuator has the first effective length shorter than that of the first actuator, and
when the substantially rigid rectangular structure is in the second elevated position, the first fastener of the first actuator is engaged with a second fastener of the substantially rigid rectangular structure and the first fastener of the second actuator is engaged with a second fastener so that the second actuator has the second effective length of about that of the first actuator and substantially rigid rectangular structure is substantially parallel to the elevated inclined surface.

7. The lifting apparatus of claim 6 wherein
the second fasteners further comprise loops formed on first and second ends of substantially rigid rectangular structure; and
the first fasteners of the elevating members further comprise protrusions for releasably engaging the loops, wherein the protrusion of the second actuator's elevating member engages the loop at the second end of the load when in the second elevated position for supporting the load therefrom and disengages from the loop in the first lowered position for enabling the second actuator to achieve the first effective length shorter than that of the first actuator so that substantially rigid rectangular structure is substantially parallel to the lower surface.

8. The lifting apparatus of claim 7 wherein the protrusions are outwardly and upwardly extending pins.

9. The lifting apparatus of claim 6 wherein the substantially rigid rectangular structure is a baggage cart.

10. The lifting apparatus of claim 6 wherein the substantially rigid rectangular structure is a wheelchair.

11. The lifting apparatus of claim 3 wherein each of the first and second actuators further comprise a drive for moving their respective elevating members axially along the fixed portion.

12. The lifting apparatus of claim 3 wherein the first and second actuators further comprise a drive for moving the elevating members axially along the fixed portion.

13. The lifting apparatus of claim 12 wherein the drive comprises a cable system operable to move the elevating members of the first and second actuators simultaneously and axially along the fixed portion.

14. The lifting apparatus of claim 3 wherein:
the fixed portion is a rail affixed substantially perpendicular to the elevated inclined surface; and
the elevating member is moveable along the rail.

15. The lifting apparatus of claim 1 wherein the elevated inclined surface is a jet bridge having an underside, the apparatus further comprising:
a mounting structure adapted for mounting to the underside and wherein the first and second actuators are connected to the mounting structure.

16. The lifting apparatus of claim 15 wherein the jet bridge underside has at least two axially extending and exposed I-beams, the mounting structure further comprising
a unitary T-shaped frame having a first beam connected at an intermediate point to a second beam, the second beam being adapted for clamping connection transversely beneath and to at least two of the jet bridge's I-beams and for aligning the first beam substantially parallel to the inclined jet bridge wherein
the second beam is adjustably positionable in a first dimension along the I-beams and adjustably positionable in second dimension transverse to the I-beams and the first and second actuators are adjustably positionable in a third dimension through connection to the first beam.

17. The lifting apparatus of claim 16 wherein each of the first and second actuators are connected to mounting flanges spaced apart along the first beam, each mounting flange having a plurality of mounting positions for mounting the respective first and second actuators.

18. The lifting apparatus of claim 12 wherein the drive further comprises:
a first sensor to determine when the load supporting structure is in the first lowered position and stop the drive; and
a second sensor to determine when the load supporting structure is in the second elevated position and stop the drive.

19. The lifting apparatus of claim 18 wherein when the load supporting structures is in the first lowered position, the drive further comprises:
a third sensor to determine when the elevated inclined surface moves and to actuate the drive to maintain the load supporting structure in the first lowered position.

20. The lifting apparatus of claim 1 wherein the lower surface is a ground surface.
